(19) United States
(12) Patent Application Publication
(10) Pub. No.: US 2003/0061674 A1
(43) Pub. Date: Apr. 3, 2003

(54) Automatic cart washer

(76) Inventor: James M. Heinlein, Moon Township, PA (US)

Correspondence Address: William H. Logsdon, 700 Koppers Building, 436 Seventh Avenue, Pittsburgh, PA, 15219-1818, US

(21) Appl. No.: 09/970,128

(22) Filed: Oct. 3, 2001

(51) Int. Cl. B60S 3/06

(52) U.S. Cl. 15/53.3; 15/DIG. 2; 134/111; 134/123

(57) ABSTRACT

An assembly for washing a golf cart includes an enclosure having two openings and a floor. A conveyor system has a belt that attaches to the golf cart and extends along the floor. The conveyor system directs the golf cart through the enclosure. A connection to a water source is in fluid communication with a plurality of outlets positioned in an interior of the enclosure and positioned to direct water onto the golf cart as it passes through the enclosure. A drying means may be provided to remove excess water from the golf cart.

### BACKGROUND OF THE INVENTION

1. Field of the Invention

The present invention is directed to an automatic cart washer and, in particular, an automatic cart washer for golf carts.

2. Description of Related Art

Many golfers choose to ride in golf carts while playing a game of golf, rather than walk during the game. Golf carts also are used by golf course employees, such as rangers, vendors, maintenance, pros. Golfers prefer to have a clean golf cart when starting their game. A dirty cart can soil clothing and body parts and attract bees and other insects. Therefore, before a golf cart is given to a golfer, the cart should be clear of dirt and grass build-up and sticky/soiled areas from spilled drinks or food. Thus, the golf carts need to be washed periodically to ensure that the golfers, and employees, have clean golf carts to use. Washing a golf cart not only keeps it clean, but also decreases maintenance and enhances the life span and resale value of the golf cart. However, hand washing several golf carts is time consuming and labor intensive (it takes about 10-20 minutes for one person to hand wash one golf cart). Many golf courses do not have the time or manpower to place the golf cart in as clean a condition as they would prefer.

### SUMMARY OF THE INVENTION

It is an object of this invention to provide an assembly for washing golf carts in a fast and efficient manner. Preferably, the assembly may be used to clean golf carts between players' rounds of golf without any undue delay in the availability of the golf cart.

An assembly for washing a golf cart includes an enclosure having two openings and a floor. A conveyor system has a belt that attaches to the golf cart and extends along the floor. The conveyor system directs the golf cart through the enclosure. A connection to a water source is in fluid communication with a plurality of outlets positioned in an interior of the enclosure and positioned to direct water onto the golf cart as it passes through the enclosure. A drying means may be provided to remove excess water from the golf cart.

### BRIEF DESCRIPTION OF THE DRAWINGS

FIG. 1 is a perspective schematic of an assembly for washing golf carts according to the present invention;

FIG. 2 is a perspective schematic of a second embodiment of an assembly for washing golf carts according to the present invention;

FIG. 3 is an end schematic of the assembly shown in FIG. 2;

FIG. 4 is a cross-sectional side schematic of an assembly for washing golf carts according to the present invention; and

FIG. 5 is a cross-sectional side schematic of an assembly for washing golf carts according to the present invention with golf carts inside an enclosure.

### DETAILED DESCRIPTION OF THE PREFERRED EMBODIMENTS

A complete understanding of the invention will be obtained from the following description when taken in connection with the accompanying drawing figures wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

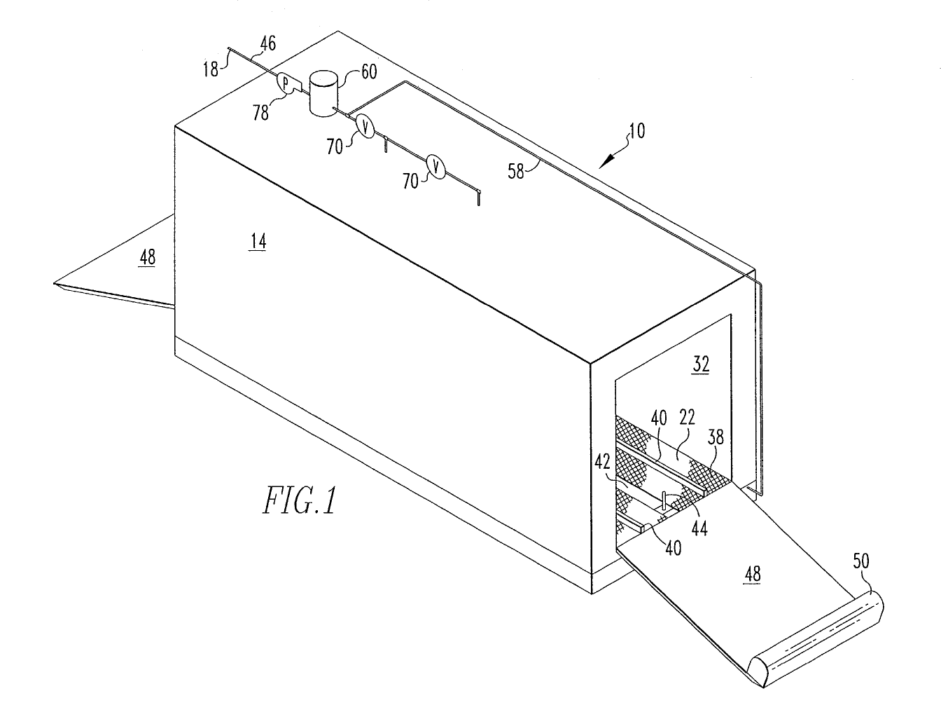

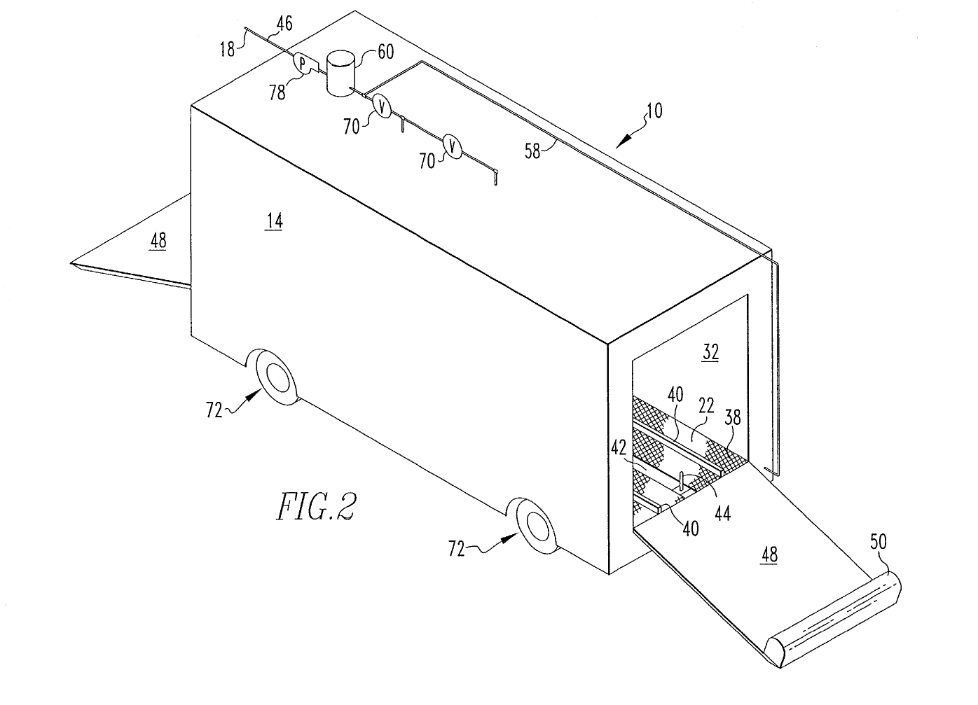

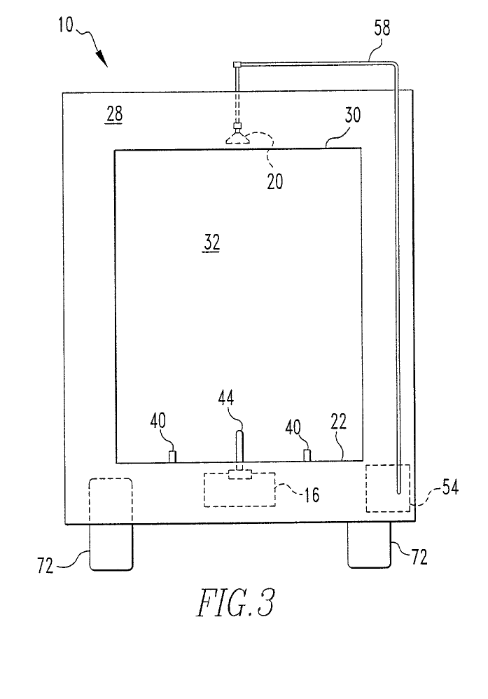

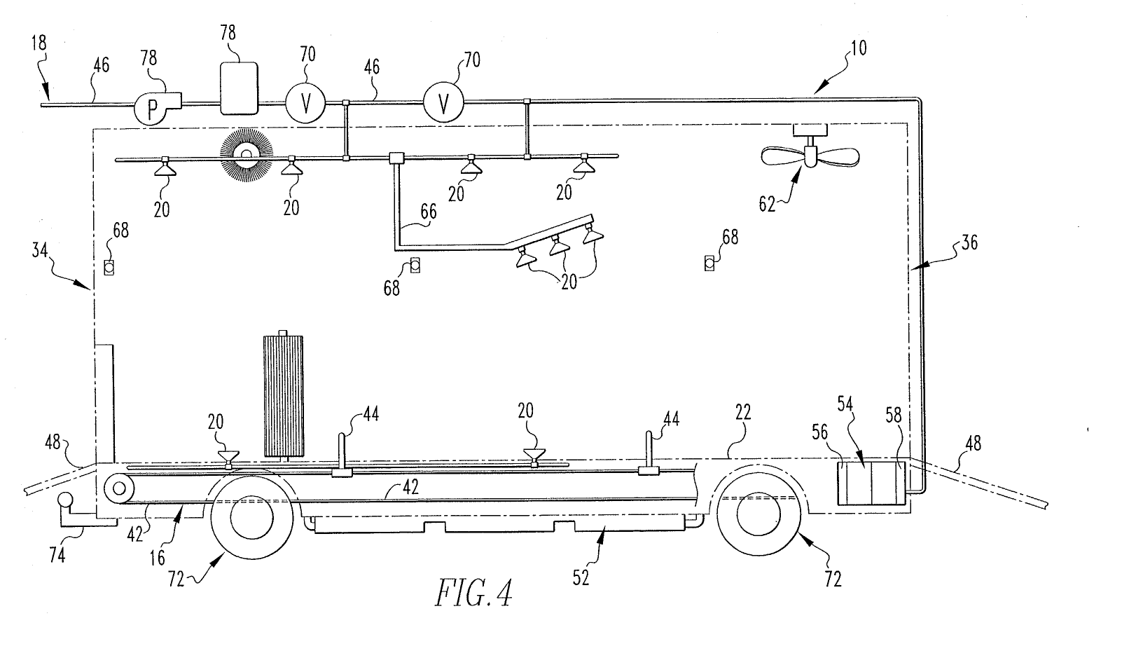

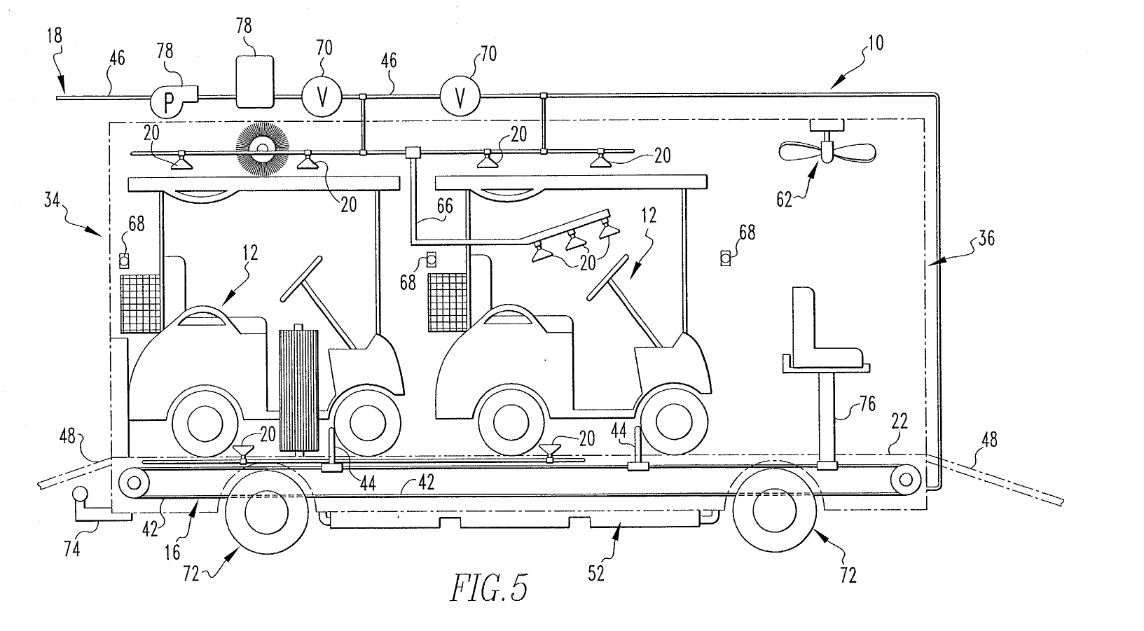

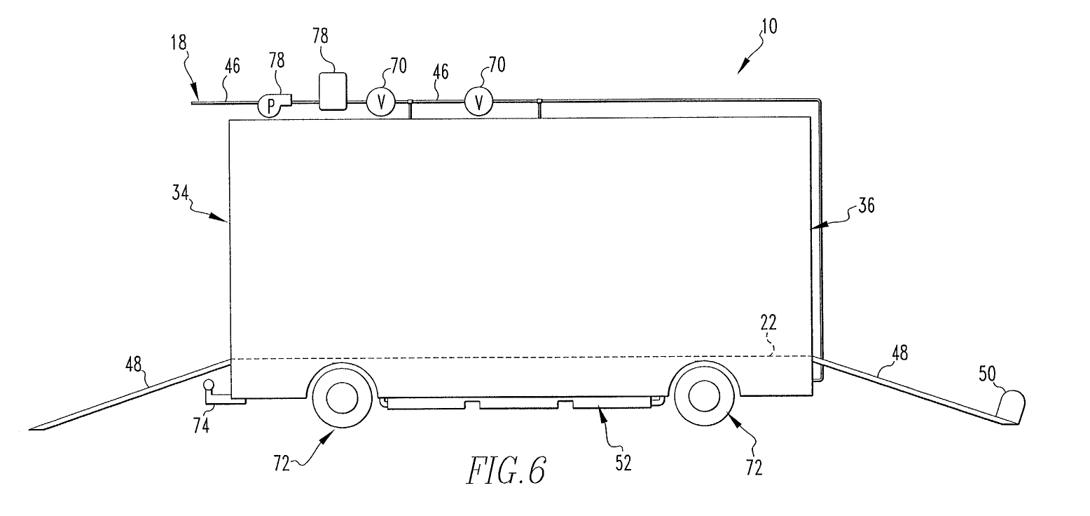

Referring to FIGS. 1-5, an assembly 10 for washing a golf cart 12 according to the present invention includes an enclosure 14, a conveyor system 16, a water source connection 18, and a plurality of outlets 20.

The enclosure 14 may be generally box-like in shape and have a floor 22, a ceiling 24, opposed sides 26, and opposed ends 28. The ends 28 each have an opening 30 that provides access to an interior 32 of the enclosure (i.e., an opening at an entry end 34 of the enclosure and another opening at an exit end 36 of the enclosure). The enclosure 14 may be constructed of any suitable material, such as heavy gauge steel sheets and square tubing. Clear material may be utilized for portions of the enclosure 14 to provide visual access to the interior 32 of the enclosure.

Preferably, a portion or all of the floor 22 includes a plurality of openings 38 through which used water and debris from the golf cart 12 may pass. For example, the floor 22 may be constructed of a commercially available steel mesh material. The floor 22 may also include guides 40, for example, two five inch steel rails parallel to each other and approximately ten inches apart, to direct the golf cart 12 through the enclosure 14.

The conveyor system 16 includes a belt 42. Preferably, the belt 42 is a continuous loop that passes along a length of the floor 22 within the enclosure 14. The belt 42 is adapted to attach to the golf cart 12 in order to move the golf cart 12 through the assembly 10 for washing. The belt 42 may have a plurality of hooks 44 that connect to an underneath of the golf cart 12, for example, to the steering shaft or axle. The hooks 44 may be eight inch pins spaced every twelve feet on the belt 42. A known gear and motor system (not shown) may drive the conveyor system 16.

The assembly 10 has a water source connection 18 to be placed in fluid communication with a water source (not shown), for example, a city or well water supply. The water source connection 18 is in fluid communication with the plurality of outlets 20 through a series of tubing 46. Each of the plurality of outlets 20 is positioned at a strategic location within the enclosure 14 for directing water exiting through the outlets 20 over the entire golf cart 12. Outlets 20 may be positioned on the ceiling 24, sides 26, ends 28, and floor 22 in the interior 32 of the enclosure 14 to wash the top, sides, front, rear, and bottom of the golf cart 12.

A ramp 48 may be provided adjacent each opening 30 in the ends 28 of the enclosure 14, for example, at a 30° incline, to facilitate smooth access to and from the enclosure 14. If the enclosure 14 is elevated from ground level, the ramps 48 provide a way to get the golf cart 12 into the enclosure 14. The golf cart 12 may be driven or pushed up the ramp 48 to the entry end 34 of the enclosure 14. Gravity helps the golf cart 12 roll down the ramp 48 at the exit end 36 of the enclosure 14. A stop 50 may be provided on either ramp 48 to prevent the golf cart 12 from rolling off of the ramp 48. The stop 50 may be movable in order to enable the removal of the golf cart 12 once the golf cart 12 encounters the stop 50. The ramps 48 may be pivotably attached to the enclosure 14 such that when the ramps 48 are pivoted to a closed position, the ramps 48 act as doors to cover the openings 30. The ramps 48 may also be detachable from the enclosure 14.

The assembly 10 may also include a basin 52 located beneath the floor 22 of the enclosure 14. For example, the basin 52 may be a commercially available 1 foot deep, 800 gallon capacity, molded plastic basin 52. The water and debris that pass through the floor 22 are caught in the basin 52 and either discarded or recycled. A drain hole with a cooperating plug (not shown) may be located in the basin 52 to facilitate emptying the basin 52.

A filter system 54 may be in fluid communication with the basin 52 to filter out the debris from the water. Thus, the water and the debris can be discarded separately or the water can be recycled. A pump 56 may be used to draw the water and debris from the basin 52 to the filter system 54. A commercially available filter system 54 and/or pump 56 may be used.

A recycle system 58 may be in fluid communication with the filter system 54 and the plurality of outlets 20. The recycle system 58 introduces clean water from the filter system 54 (i.e., water from which debris has been removed) to the plurality of outlets 20. The clean water may be mixed with water from the water source or, after enough clean water is produced, used as the sole source of water for the assembly 10.

The assembly 10 may include a cleanser dispensing source 60 in fluid communication with the plurality of outlets 20. The cleanser dispensing source 60 would provide a cleanser, such as soap or bleach, that is mixed with water to flow out of the outlets 20. The cleanser dispensing source 60 may be supplied by a commercial dealer.

A drying means 62 is preferably located at an exit end 36 of the enclosure 14. Once the golf cart 12 has passed the plurality of outlets 20, the drying means 62 removes any excess water from the golf cart 12. The drying means 62 may include a fan, a blower, an air curtain, and/or any other conventional drying means.

The assembly 10 preferably includes a plurality of brushes 64 positioned strategically in the interior 32 of the enclosure 14. Each brush 64 may rotate, driven by a power source (not shown) or by the passing golf cart 12. As the golf cart 12 passes the brushes 64, the brushes remove dirt and debris from the golf cart 12, for example, from the top, sides, front, rear, and bottom of the golf cart. The plurality of brushes 64 may be any combination of commercially available or custom designed brushes.

The assembly 10 may further include at least one movable arm 66 (for example, hinged at the connection point with the enclosure 14) having at least one of the outlets 20. The arm 66 is positioned and shaped to enable washing of the interior components of the golf cart 12, for example, a seat, a steering wheel, a gas pedal, a brake, an underside of a roof, etc. The arm 66 may have several outlets 20 arranged at various locations on the arm 66 so that water is directed in different directions to reach the various areas of the golf cart 12.

A plurality of sensors 68 may be strategically positioned within the interior of the enclosure. A plurality of valves 70 may be strategically positioned between the water source and the plurality of outlets 20. In this configuration, the sensors 68 sense the presence of the golf cart 12 in a particular position within the enclosure 14 and control the operation of defined sections within the enclosure 14, for example, a pre-rinse section, a wash section, a rinse section, and a drying section.

The assembly 10 may derive power from any conventional source. For example, the assembly may include a connection (not shown) to an external electrical power source or include commercial generator or a battery (not shown).

A plurality of wheels 72 may be rotatably attached to the enclosure 14 to provide mobility to the assembly 10. Additionally, a tow mechanism 74 may be attached to the assembly 10 such that the assembly 10 can be connected to a vehicle (not shown) to tow the assembly 10. With mobility, the assembly 10 may be moved to any location desired, for example, to another location in the golf course or to another golf course. Alternatively, the assembly 10 may be placed on a trailer (not shown) for mobility.

A rack 76 may be attachable to the belt 42 to transport items related to the golf cart 12 through the assembly 10. For example, the seat of the golf cart 12 may be removed and placed on the rack 72. When the golf cart 12 goes through the assembly 10, the area underneath the seat (e.g., an engine compartment) would be cleaned, as well as the seat itself.

The assembly 10 may include a pump 78 positioned between the water source connection 18 and the plurality of outlets 20 to force water out through the plurality of outlets 20.

A number of outlets 20 may be hand-operated. Hand-operated outlets 20 located near an entry end 34 of the assembly 10 can be operated to pre-rinse the golf cart 12, remove stubborn debris, etc. Hand-operated 20 outlets located near an exit end 36 of the assembly 10 can be operated to remove any debris not removed by the assembly 10.

In use of a basic assembly 10, according to the invention, a golf cart 12 is forced (by driving or pushing) up the ramp 48 at the entry end 34 and slightly into the enclosure 14. The golf cart 12 is placed into neutral. One hook 44 in the belt 42 of the conveyor system 16 is placed in engagement with the steering bar on the underside of the golf cart 12. The conveyor system 16 is turned on, and the belt 42 pulls the golf cart 12 through the enclosure 14. Water flows out of the plurality of outlets 20 directed to the golf cart 12. The golf cart 12 continues through the enclosure 14 to the exit end 36. The hook 44 is disengaged from the golf cart 12, and the golf cart 12 rolls down the ramp 48.

In another embodiment of the assembly 10, the assembly 10 is initially turned on by providing power to the assembly 10. The conveyor system 16 continuously runs, and one hook 44 will automatically engage the underside of the golf cart 12 when present at the entry end 34 of the enclosure 14. As the golf 12 cart travels through the enclosure 14, a pre-rinse section is first encountered. Here, only water is delivered through the outlets 20 to initially rinse the golf cart 12. Sensors 68 located in the interior 32 of the enclosure 14 at the entry end 34 of the enclosure 14 sense the presence of the golf cart 12 and initiate water flow to and out of the plurality of outlets 20 in the pre-rinse section.

Next is a wash section where soap is dispensed by the cleanser dispensing source 60 into the water stream and flows through the outlets 20. Brushes 64 are strategically positioned along the interior of the enclosure 14, for example, on the sides 26, ends 28, ceiling 24, and floor 22, to scrub the golf cart 12 on the top, sides, and bottom. A moveable arm 66 is automatically extended into the interior of the golf cart 12 to spray water and soap in the interior of the golf cart 12. Sensors 68 located in the interior of the enclosure 14 at the beginning of the wash section sense the presence of the golf cart 12. At that time, the valves 70 are controlled to cease water flow in the pre-rinse section and to initiate water and soap flow to and out of the plurality of outlets 20 in the wash section.

The next section is a rinse section. Here, only water is delivered through the outlets 20. The golf cart 12 is rinsed to remove soap applied in the previous section and any remaining debris. A moveable arm 66 is automatically extended into the interior of the golf cart 12 to spray water in the interior of the golf cart 12 to remove soap and debris. Sensors 68 located in the interior of the enclosure at the beginning of the rinse section sense the presence of the golf cart 12. At that time, the valves 70 are controlled to cease water and soap flow in the wash section and initiate water flow to and out the plurality of outlets 20 in the rinse section.

The last section is a drying section. Here, drying means 62 is present to blow excess water from the golf cart 12. When the golf cart 12 reaches the exit end 36 of the enclosure 14, the hook 44 is automatically disengaged from the underside of the golf cart 12 and the golf cart 12 rolls down the ramp 48. The stop 50 at the end of the ramp 48 prevents the golf cart 12 from rolling away. An operator may then remove the golf cart 12 from the assembly 10 by moving the stop 50 and pushing or driving the golf cart 12 away. Sensors 68 located in the interior 32 of the enclosure 14 at the beginning of the drying section sense the presence of the golf cart 12. At that time, the valves 68 are controlled to cease water flow in the rinse section and the drying means 62 is turned on.

Sensors 68 located in the interior 32 of the enclosure 14 at the end of the drying section sense the presence of the golf cart 12. At that time, the drying means 62 is turned off.

Preferably, as one golf cart 12 nears the exit end 36 of the enclosure 14, another golf cart 12 is loaded at the entry end 34. A wash cycle preferably takes 2 to 2.5 minutes, allowing 100 golf carts 12 to be cleaned in 3.5 hours.

It will be understood by those skilled in the art that while the foregoing description sets forth in detail preferred embodiments of the present invention, modifications, additions, and changes might be made thereto without departing from the spirit and scope of the invention.

I claim:

1. An assembly for washing a golf cart, comprising:
an enclosure having two openings and a floor, each opening sized and shaped to allow the golf cart to pass therethrough;
a conveyor system having a belt extending along the floor, the belt adapted to engage the golf cart;
a connection to a water source;
a plurality of outlets positioned in an interior of the enclosure and in fluid communication with the connection to the water source,
wherein as the conveyor system moves the golf cart through the enclosure, water from the water source is directed onto the golf cart by the plurality of outlets.

2. The assembly as claimed in claim 1, further including a ramp adjacent each opening to facilitate access to and from the enclosure.

3. The assembly as claimed in claim 2, wherein each ramp is pivotably connected to the enclosure to close off the corresponding opening when in a closed position.

4. The assembly as claimed in claim 3, wherein each ramp is detachable from the enclosure.

5. The assembly as claimed in claim 1, further including a basin located beneath the floor, wherein the floor has a plurality of openings through which water and debris may pass into the basin.

6. The assembly as claimed in claim 5, further including a filter system in fluid communication with the basin, wherein water and debris in the basin pass to the filter system to separate the debris from the water.

7. The assembly as claimed in claim 6, further including a recycle system in fluid communication with the filter and with the plurality of outlets, wherein filtered water is reintroduced to the plurality of outlets.

8. The assembly as claimed in claim 1, wherein a number of the plurality of outlets is further in fluid communication with a cleanser dispensing source.

9. The assembly as claimed in claim 1, further including a drying means at a discharge end of the enclosure.

10. The assembly as claimed in claim 1, further including a plurality of brushes positioned in the interior of the enclosure and engageable with the golf cart.

11. The assembly as claimed in claim 10, wherein each of the plurality of brushes is rotatable.

12. The assembly as claimed in claim 1, further including at least one moveable arm in the interior of the enclosure, wherein at least one outlet is located on the at least one arm and positioned to direct water to an interior of the golf cart.

13. The assembly as claimed in claim 1, further including a plurality of sensors, the sensors sense the presence of the golf cart in defined sections of the enclosure and control operation of the plurality of outlets, a drying means, and a plurality of brushes.

14. The assembly as claimed in claim 1, further including a connection electrically connectable to an external electric power source.

15. The assembly as claimed in claim 1, further including a plurality of wheels rotatably connected to the enclosure, and a tow mechanism removably attachable to a means for towing the assembly.

16. The assembly as claimed in claim 1, further including a rack attachable to the conveyor and configured to carry a cart seat through the enclosure.

17. The assembly as claimed in claim 1, further including a means for forcing water from the water source through the outlets.

18. The assembly as claimed in claim 1, wherein a number of the plurality of outlets is hand-operated.

19. A golf cart washer, comprising:
an enclosure having an entrance, an exit, and a floor;
a transport system engaging the golf cart and directing the golf cart through the enclosure;
a plurality of outlets in each of a pre-rinse section, a wash section, and a rinse section of the enclosure and in fluid communication with a water supply;
a plurality of brushes in the wash section; and
a drying mechanism in a drying section of the enclosure.

20. The golf cart washer as claimed in claim 19, further including a plurality of wheels attached to the enclosure.
